(19) United States
(12) Patent Application Publication
(10) Pub. No.: US 2026/0149914 A1
(43) Pub. Date: May 28, 2026

(54) AUDIO DEVICE OPTIMIZATION WITH MICROPHONE CALIBRATION

(71) Applicant: Bose Corporation, Framingham, MA (US)

(72) Inventors: James Michael McHugh, Jamaica Plain, MA (US); Guy Torio, Holliston, MA (US); Brian R. White, Hudson, MA (US)

(73) Assignee: Bose Corporation, Framingham, MA (US)

(21) Appl. No.: 18/957,016

(22) Filed: Nov. 22, 2024

(51) Int. Cl. H04R 1/26; H04R 29/00

(52) U.S. Cl. CPC H04R 1/26; H04R 29/004; H04R 2420/07; H04R 2460/07; H04R 2499/11

(57) ABSTRACT

An audio device including at least one acoustic transducer and a controller is provided. The controller is configured to (1) render microphone calibration audio via the at least one acoustic transducer; (2) wirelessly receive a microphone calibration data set corresponding to the microphone calibration audio; (3) render sound optimization audio via the at least one acoustic transducer; (4) wirelessly receive a sound optimization data set corresponding to the sound optimization audio at a first listening location; (5) generate an equalization parameter based on the sound optimization data set and the microphone calibration data set; (6) generate an optimized output audio signal based on an output audio data set and the equalization parameter; and (7) render the optimized output audio via the at least one acoustic transducer based on the optimized output audio signal.

### FIELD OF THE DISCLOSURE

The present disclosure is generally directed to audio device optimization, and more specifically, to calibrating for a microphone used in the optimization process.

### BACKGROUND

An audio device, such as a soundbar or a smart speaker, may be optimized for particular environments by capturing and processing audio rendered by the audio device at certain locations within the environment. Currently, this audio is typically captured using a specialized headset with a previously characterized microphone. This headset is typically provided by the manufacturer when the audio device is purchased.

### SUMMARY

The present disclosure is generally directed to systems and methods for optimizing audio rendered by an audio device, such as a soundbar or a smart speaker. Rather than relying on a specialized headset with a previously characterized microphone, the systems and methods may use any wirelessly enabled mobile device (such as a smart phone) to perform the optimization. In particular, the audio device is configured to perform a calibration routine to compensate for the variations of the various types of microphones implemented in different models of mobile devices.

To calibrate for the microphone being used as part of the optimization process, the mobile device is positioned on or near (such as, for example, within 3 inches) the audio device. The acoustic transducers of the audio device render microphone calibration audio. The microphone (or microphone array) of the mobile device captures the microphone calibration audio and stores the captured audio as a microphone calibration data set. The mobile device then wirelessly transmits (such as via Wi-Fi, Bluetooth, or other appropriate wireless communication protocol) the microphone calibration data set to the audio device. The audio device then continues the optimization process by moving the mobile device to a first location in an environment containing the audio device, and triggering the audio device to render sound optimization audio. The mobile device captures the sound optimization audio and stores the captured audio as a sound optimization data set. The mobile device then wirelessly transmits the sound optimization data set to the audio device. Additional (such as, for example, three to five) sound optimization data sets may be collected at different locations and transmitted to the audio device. Upon receiving the sound optimization data sets, the audio device then generates an equalization parameter based on the sound optimization data sets and microphone calibration data set. The equalization parameter may include equalization curves across the range of audible sound for each of the acoustic transducers of the audio device. Using the microphone calibration data set ensures that the equalization parameter is microphone-agnostic. Any output audio subsequently rendered by the audio device is processed by the equalization parameter to provide optimized output audio within the environment.

In some examples, the audio device may also include a reference microphone to further refine the mobile device microphone calibration process. The reference microphone is used to capture the microphone calibration audio rendered by the acoustic transducers of the audio device and store the captured audio as a reference audio data set. The audio device then uses this reference audio data set to augment the determination of the equalization parameter. As the audio device knows the various properties of the reference microphone, the audio device is able to use the reference audio data set to more accurately determine the impact of the properties of the mobile device microphone on the microphone calibration audio, thereby allowing the audio device to more accurately compensate for the properties of the mobile device microphone when optimizing output audio.

Generally, in one example, an audio device is provided. The audio device includes at least one acoustic transducer and a controller. The controller is configured to render microphone calibration audio via the at least one acoustic transducer.

The controller is further configured to wirelessly receive a microphone calibration data set corresponding to the microphone calibration audio.

The controller is further configured to render sound optimization audio via the at least one acoustic transducer.

The controller is further configured to wirelessly receive a sound optimization data set corresponding to the sound optimization audio at a first listening location.

The controller is further configured to generate an equalization parameter based on the sound optimization data set and the microphone calibration data set.

The controller is further configured to generate an optimized output signal based on an output audio data set and the equalization parameter.

The controller is further configured to render the optimized output audio via the at least one acoustic transducer based on the optimized output signal.

According to an example, the audio device may further include a reference microphone. The reference microphone may be configured to capture a reference audio data set corresponding to the microphone calibration audio. The equalization parameter may be further based on the reference audio data set.

According to an example, the microphone calibration data set and/or the sound optimization data set is received via Wi-Fi.

According to an example, the microphone calibration data set corresponds to audio captured proximate to the audio device.

According to an example, the audio device is a soundbar.

According to an example, the microphone calibration data set is wirelessly received from a mobile device.

According to an example, the sound optimization data set is wirelessly received from a mobile device.

According to an example, the controller is further configured to (1) render second sound optimization audio via the at least one acoustic transducer; and (2) wirelessly receive a second sound optimization data set corresponding to the second sound optimization audio at a second listening location. The equalization parameter may be further based on the second sound optimization data set.

According to an example, the microphone calibration audio and/or the sound optimization audio are within a frequency range of 20 Hz to 20 kHz.

Generally, according to another example, a method for optimizing output audio rendered by an audio device is provided. The method includes (1) rendering microphone calibration audio via at least one acoustic transducer of the audio device; (2) wirelessly receiving, via the audio device, a microphone calibration data set corresponding to the microphone calibration audio; (3) rendering sound optimization audio via the at least one acoustic transducer of the audio device; (4) wirelessly receiving, via the audio device, a sound optimization data set corresponding to the sound optimization audio at a first listening location; (5) generating, via a controller of the audio device, an equalization parameter based on the sound optimization data set and the microphone calibration data set; (6) generating, via the controller of the audio device, an optimized output signal based on an output audio data set and the equalization parameter; and (7) rendering optimized output audio via the at least one acoustic transducer of the audio device based on the optimized output signal.

According to an example, the microphone calibration data set is captured by a mobile device arranged proximate to the audio device.

According to an example, the mobile device is arranged on top of the audio device.

According to an example, the method further includes capturing, via a reference microphone of the audio device, a reference audio data set corresponding to the microphone calibration audio. The equalization parameter is further based on the reference audio data set.

According to an example, the microphone calibration data set and/or the sound optimization data set is received via Wi-Fi.

According to an example, the audio device is a soundbar.

According to an example, the sound optimization data set is captured by a mobile device positioned at the first listening location.

According to an example, the sound optimization data set is wirelessly received from a mobile device.

According to an example, the method further includes (1) rendering second sound optimization audio via the at least one acoustic transducer of the audio device; and (2) wirelessly receiving, via the audio device, a second sound optimization data set corresponding to the second sound optimization audio at a second listening location. The equalization parameter is further based on the second sound optimization data set.

According to an example, the second sound optimization data set is captured by a mobile device positioned at the second listening location.

According to an example, the microphone calibration audio and/or the sound optimization audio are within a frequency range of 20 Hz to 20 kHz.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1A is a top view of an environment with an audio device and a mobile device, wherein the mobile device is arranged on top of the audio device, in accordance with an example.

FIG. 1B is a side view of an environment with an audio device and a mobile device, wherein the mobile device is arranged on top of the audio device, in accordance with an example.

FIG. 1C is a side view of an environment with an audio device and a mobile device, wherein the mobile device is arranged away from the audio device, in accordance with an example.

FIG. 2A is a top view of a mobile device arranged on an audio device, in accordance with an example.

FIG. 2B is a side view of a mobile device arranged away from an audio device, in accordance with an example.

FIG. 3A is a functional block diagram of aspects of an audio device, in accordance with an example.

FIG. 3B is a functional block diagram of further aspects of an audio device, in accordance with an example.

FIGS. 4A and 4B are a flow chart of a method for optimizing output audio rendered by an audio device, in accordance with an example.

### DETAILED DESCRIPTION

The present disclosure is generally directed to systems and methods for optimizing audio rendered by an audio device, such as a soundbar or a smart speaker. Rather than relying on a specialized headset with a previously characterized microphone, the systems and methods may use any wirelessly enabled mobile device (such as a smart phone) to perform the optimization. In particular, the audio device is configured to perform a calibration routine to compensate for the variations of the various types of microphones implemented in different models of mobile devices.

To calibrate for the microphone being used as part of the optimization process, the mobile device is positioned on or near the audio device. The acoustic transducers of the audio device render microphone calibration audio. The microphone of the mobile device captures the microphone calibration audio and stores the captured audio as a microphone calibration data set. The mobile device then wirelessly transmits the microphone calibration data set to the audio device. The audio device then continues the optimization process by moving the mobile device to a first location in an environment containing the audio device, and triggering the audio device to render sound optimization audio. The mobile device captures the sound optimization audio and stores the captured audio as a sound optimization data set. The mobile device then wirelessly transmits the sound optimization data set to the audio device. Additional sound optimization data sets may be collected at different locations and transmitted to the audio device. Upon receiving the sound optimization data sets, the audio device then generates an equalization parameter based on the sound optimization data sets and microphone calibration data set. Any output audio subsequently rendered by the audio device is processed by the equalization parameter to provide optimized output audio within the environment. In some examples, the audio device may also include a reference microphone to further refine the microphone calibration process.

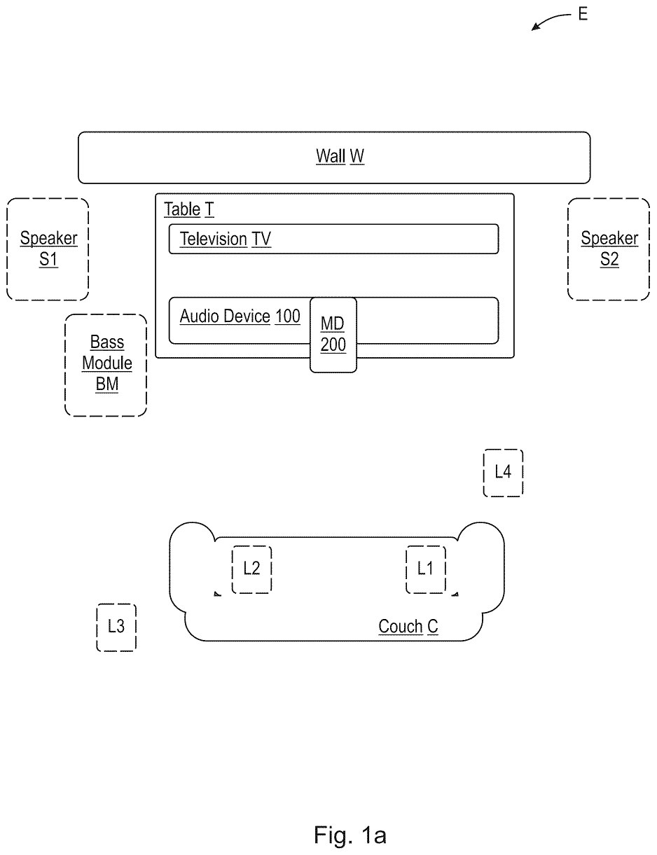

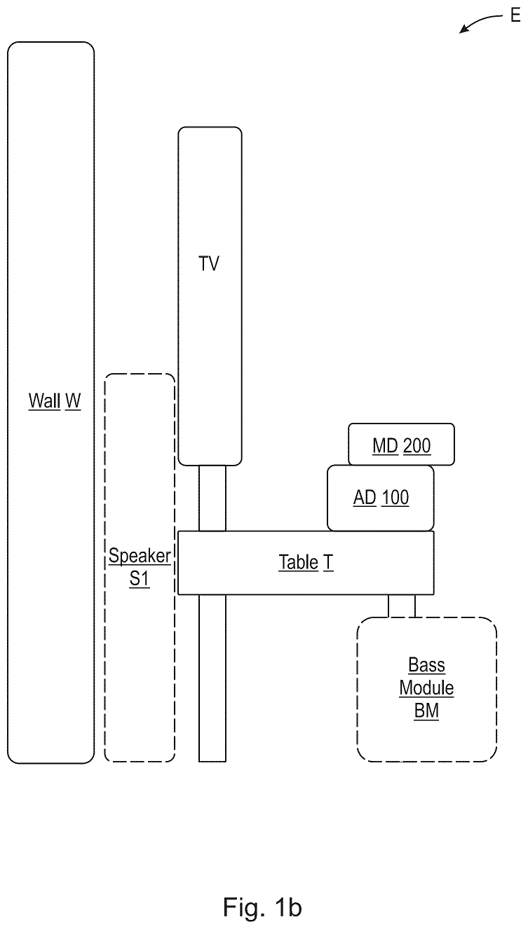

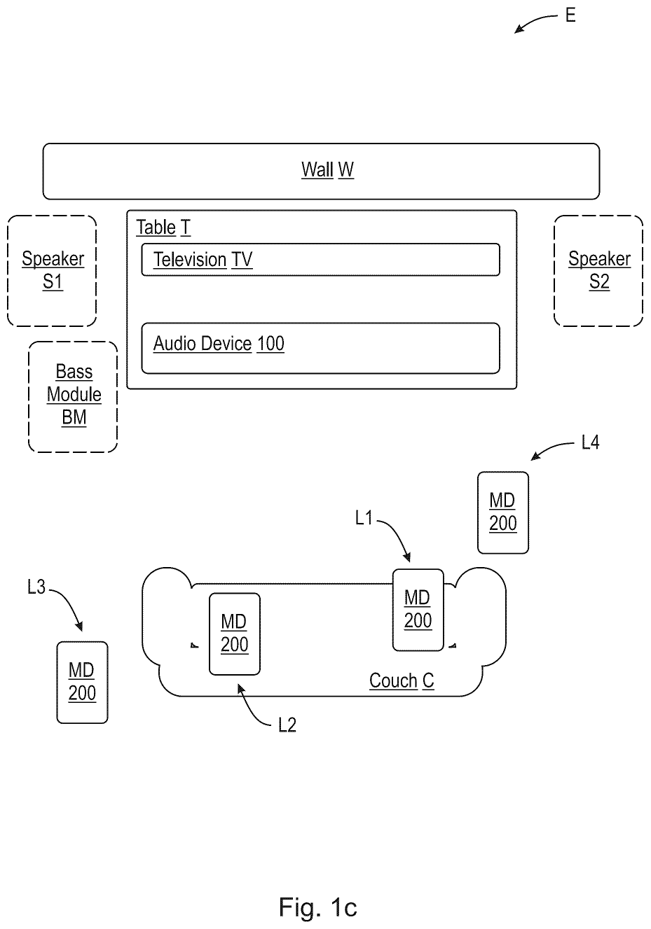

The following description should be read in view of FIGS. 1-4B.

FIGS. 1A-1C illustrate a non-limiting example of an environment E, such as a living room, home theater room, with an audio device 100. In the non-limiting examples of FIGS. 1A-1C, the audio device 100 is embodied as a soundbar. In other examples, the audio device 100 may be embodied as a smart speaker. In even further examples, the audio device 100 may be any other wirelessly enabled device capable of generating sound to be heard by a user in the environment E. As shown in FIGS. 1A-1C, the audio device 100 is positioned on a table T in front of a television TV. The audio device 100 may be communicatively connected to the television TV via any combination of wired or wireless communication to generate audio corresponding to the content displayed by the television TV. The table T and television TV are arranged near a wall W. A couch C is arranged and oriented within the environment E such that a user U may watch the television TV while sitting on the couch C. Optionally, the environment E may also include additional audio devices, such as a first speaker S1 and a second speaker S2. The first and second speakers S1, S2 may be communicatively connected to the audio device 100 via any combination of wired or wireless communication to render audio. The bass module BM may be embodied as a wirelessly enabled subwoofer speaker. The bass module BM may be communicatively connected to audio device 100 via any combination of wired or wireless communication to generate additional low frequency audio corresponding to the audio generated by the audio device 100.

FIGS. 1A-1C also illustrate a mobile device 200 positioned within the environment E. The mobile device 200 may be any device with a microphone capable of capturing audio and a transceiver capable of wirelessly transmitting data corresponding to the captured audio. In some examples, the mobile device 200 may be a smartphone. As will be described in more detail below, the mobile device 200 is used to optimize the audio generated by the audio device 100 for the acoustics of the environment E. The acoustics of the environment E may be impacted by the aspects of the environment E shown in FIGS. 1A-1C, such as the distance between the audio device 100 and the wall W. Current systems and methods for such an optimization include the ADAPTiQ® audio calibration system offered by Bose Corporation, and typically require a specialized headset with a previously characterized microphone rather than a user's mobile device 200 of unknown make and model. As part of this optimization, the mobile device 200 captures audio generated by the audio device 100 at various locations L1-L4 within the environment E and wirelessly transmits data corresponding to this captured audio back to the audio device 100. The particular locations L1-L4 may correspond to areas where the user prefers to listen to the audio generated by the audio device 100. In the example of FIGS. 1A-1C, locations L1-L4 also correspond to an area where the user can observe the content displayed by the television TV. Location L1 and location L2 are positioned on the couch C, while location L3 and location L4 are at positions around the couch C. The audio generated by the audio device 100 may include test tones corresponding to particular frequencies of interest. The audio may further include audio sweeps of a range of frequencies. The frequency of the audio generated by the audio device 100 may range from approximately 20 Hz to approximately 20 kHz. In further examples, the captured audio may also include audio rendered by one or both of the speakers S1, S2 and/or the bass module BM.

In order to perform a successful optimization for the environment E, the characteristics of the microphone of the mobile device 200 must be determined. FIGS. 1A and 1B illustrate an arrangement used to obtain audio data to characterize the microphone. As can be seen in FIGS. 1A and 1B, the mobile device 200 is placed on top of the audio device 100. Accordingly, the audio device 100 can capture the audio generated by the audio device 100 with minimal impact from the acoustics of the environment E. In other examples, rather than placing the mobile device 200 on top of the audio device 100, the mobile device 200 may be arranged next to and touching the audio device 100. In even further examples, the mobile device 200 may be positioned very close to, but not touching, the audio device. In these examples, the mobile device 200 may be three inches or less from the audio device. Once the mobile device 200 captures the audio generated by the audio device 100, the mobile device 200 wirelessly transmits data corresponding to the audio back to the audio device 100. This wireless transmission may be facilitated via a Wi-Fi connection. In other examples, this wireless transmission may be facilitated by any practical wireless protocol, such as Bluetooth. The audio device 100 then uses this data to characterize the microphone of the mobile device 200 for more accurate sound optimization. In further examples, the audio device 100 may augment the audio captured by the mobile device 200 with audio captured by a reference microphone arranged or embedded within the audio device 100.

Once the audio device 100 receives the data from the mobile device 200 for the microphone characterization process, the mobile device 200 is moved to a particular location of interest within the environment for sound optimization. As shown in FIG. 1C, the first location L1 may be on the right side of the couch C. The audio device 100 again plays audio for the mobile device 200 to capture, and the mobile device 200 wirelessly transmits data corresponding to the captured audio back to the audio device 100. This process is then repeated for several locations L2-L4 within the environment E. In some locations, the process may be repeated for between three and six total locations. With the audio captured at these various locations L1-L4, as well as the audio captured on or very close to the audio device 100, the audio device 100 may determine how to equalize the output audio to optimize for the environment E.

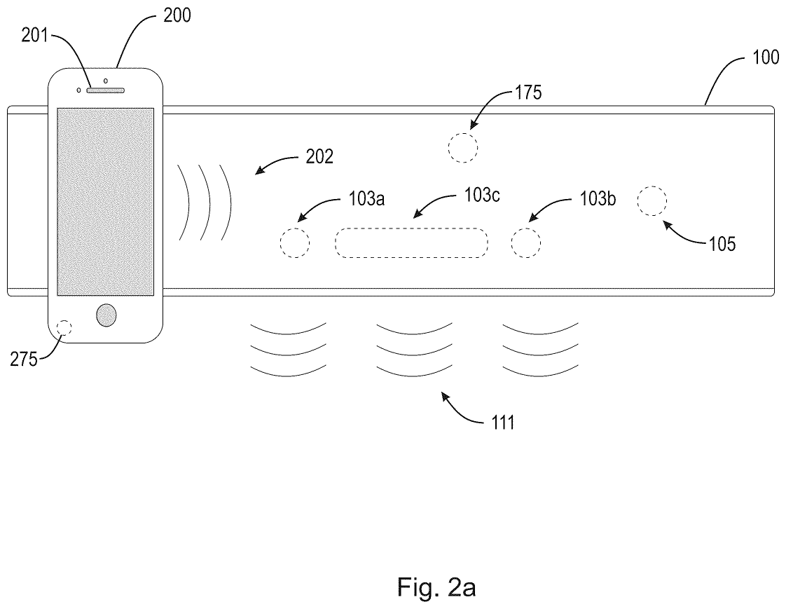

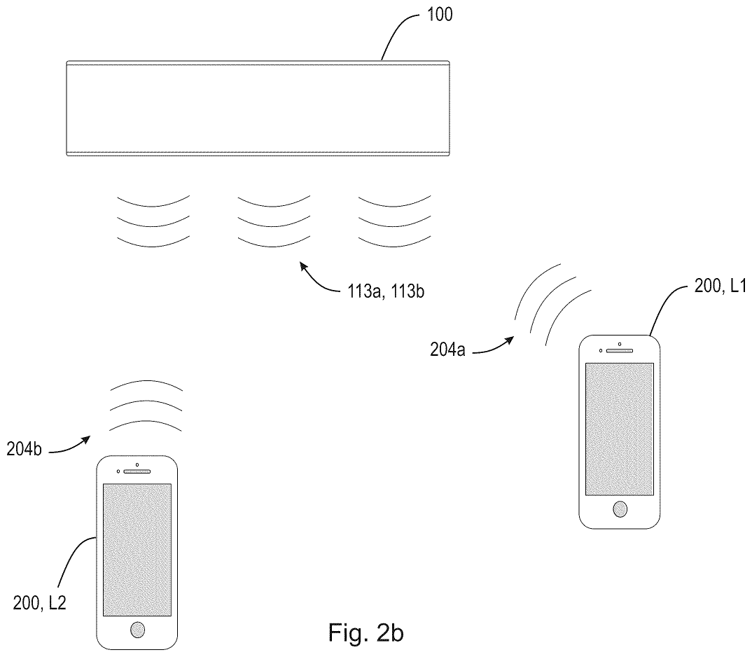

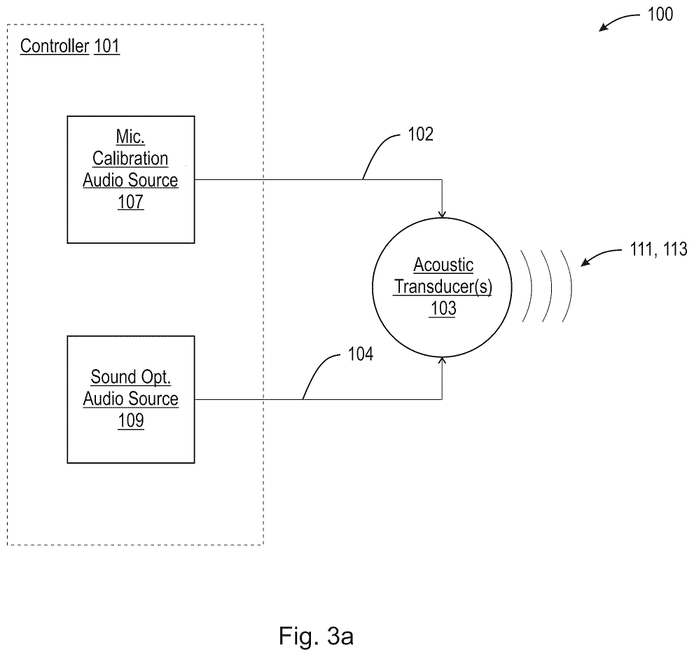

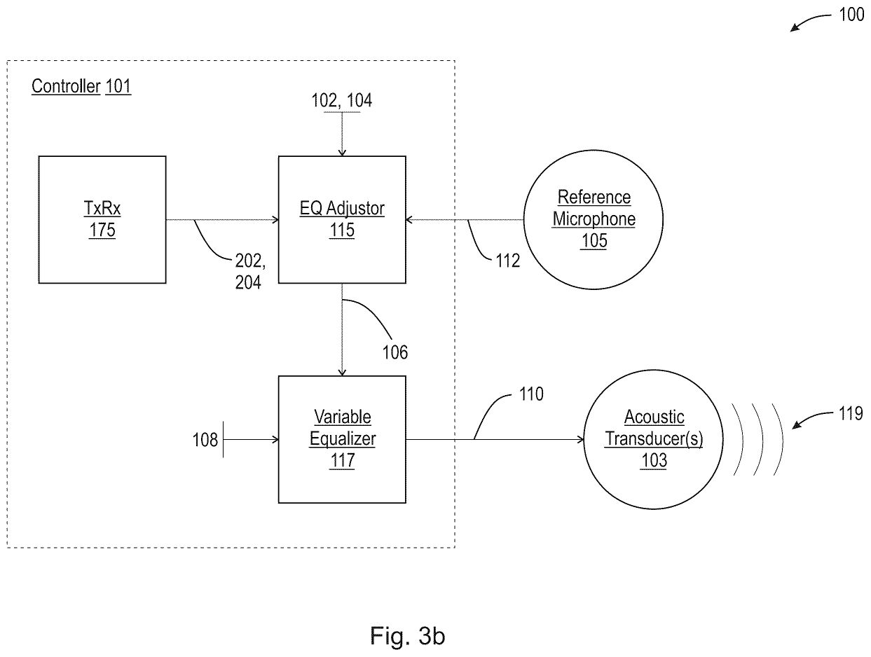

FIGS. 2A and 2B illustrate the microphone characterization and sound optimization processes described above in further detail. In particular, FIG. 2A illustrates a non-limiting example of the microphone characterization process. FIG. 2A illustrates the audio device 100 (embodied as a soundbar) and the mobile device 200 (embodied as a smartphone). The audio device 100 includes three acoustic transducers 103a-103c, a reference microphone 105, and a transceiver 175. The audio device 100 may also include a controller 101 (as shown in FIGS. 3A and 3B) having a processor and a memory to process and/or store data. While the example of FIG. 2A illustrates three acoustic transducers 103a-103c, the audio device 100 may include any practical number of acoustic transducers 103. In some examples, the audio device 100 may include as many as nine acoustic transducers 103. These acoustic transducers 103 may vary in a number of characteristics, such as size, shape, frequency range, etc. Similarly, while the reference microphone 105 is depicted as a single microphone, the reference microphone 105 may be embodied as an array of two or more microphones of various shapes, sizes, and characteristics. Further, the mobile device 200 includes a microphone 201 and a transceiver 275.

As shown in FIG. 2A, the audio device 100 renders microphone calibration audio 111. As previously described, the microphone calibration audio 111 may include audio test tones or audio frequency sweeps. The microphone calibration audio 111 is captured by the microphone 201 of the mobile device 200. The mobile device 200 then wirelessly transmits (via, for example, a Wi-Fi connection) a microphone calibration data set 202 corresponding to the captured microphone calibration audio 111. The transceiver 175 of the audio device 100 receives the microphone calibration data set 202. The microphone calibration data set 202 is then used by the audio device 100 to characterize the microphone 201 of the mobile device 200. In further examples, the microphone calibration audio 111 is also captured by the reference microphone 105 of the audio device 100. As shown in FIG. 3B, a reference audio data set 112 corresponding to the captured microphone calibration audio 111 is also used to characterize the microphone 201 of the mobile device 200.

FIG. 2B then illustrates the sound optimization process. As shown in FIG. 2B, the mobile device 200 is moved further from the audio device 100, such as at one of the locations L1-L4l shown in FIG. 1C. In this non-limiting example, the mobile device 200 is first moved to the first location L1. Once the mobile device 200 is positioned at the first location L1, the audio device 100 renders first sound optimization audio 113a. The first sound optimization audio 113a is captured by the microphone 201 of the mobile device 200. The transceiver 275 of the mobile device 200 then transmits a first sound optimization data set 204a to the audio device 100, and the transceiver 175 of the audio device 100 receives the first sound optimization data set 204a. The mobile device 200 is then moved to a second location L2 and the process is repeated. The audio device 100 generates second sound optimization audio 113b. The second sound optimization audio 113b is captured by the microphone 201 of the mobile device 200. The transceiver 275 of the mobile device 200 then transmits a second sound optimization data set 204b to the audio device 100, and the transceiver 175 of the audio device 100 receives the second sound optimization data set 204b. This process may be repeated until sufficient sound optimization data sets 204 have been collected to optimize the output audio of the audio device 100 for the acoustic characteristics of the environment E.

In further examples of the sound optimization process, additional audio devices, such as the speakers S1, S2 and the bass module BM shown in FIGS. 1A, 1C, may also generate sound optimization audio. In these examples, the speakers S1, S2 and/or the bass module BM may be wirelessly connected and synchronized with the audio device 100 to render the sound optimization audio when the audio device generates sound optimization audio 113. The audio rendered by the speakers S1, S2 and/or the bass module BM is captured (along with sound optimization audio 113 rendered by the audio device 100) by the microphone 201 of the mobile device 200 and incorporated into the sound optimization data set 204 transmitted from the mobile device 200 to the audio device 100 and used by the audio device 100 to optimize the output audio of the audio device 100.

FIG. 3A illustrates a functional block diagram of aspects of the audio device 100. In particular, the audio device 100 includes a controller 101 and one or more acoustic transducers 103. The controller may include one or more processor and memory elements to process and/or store data. To calibrate the microphone 201 of the mobile device 200 shown in the previous figures, the mobile device 200 is placed on or near the audio device 100 and a microphone calibration audio source 107 generates a microphone calibration signal 102. This microphone calibration signal 102 is provided to the acoustic transducers 103 which render microphone calibration audio 111 based on the microphone calibration signal 102. The microphone calibration audio 111 may include test tones corresponding to particular frequencies of interest. The microphone calibration audio 111 may further include audio sweeps of a range of frequencies. The frequency of the audio generated by the acoustic transducers 103 may range from approximately 20 Hz to approximately 20 kHz.

Once the microphone 201 of the mobile device 200 has been characterized, the mobile device 200 is moved away from the audio device 100 to a sound optimization location, such as locations L1-L4 shown in FIGS. 1A and 1C. A sound optimization audio source 109 the generates a sound optimization signal 104. This sound optimization signal 104 is provided to the acoustic transducers 103 which render sound optimization audio 113 based on the sound optimization signal 104. Like the microphone calibration audio 111, the sound optimization audio 113 may include test tones corresponding to particular frequencies of interest. The sound optimization audio 113 may further include audio sweeps of a range of frequencies. The frequency of the audio generated by the acoustic transducers 103 may range from approximately 20 Hz to approximately 20 kHz. In some examples, the microphone calibration audio 111 may be identical to the sound optimization audio 113. In other examples, the microphone calibration audio 111 may be identical to the sound optimization audio 113 in one or more characteristics, such as volume, frequency, duration, etc. As mentioned above, in some examples, additional devices, such as a speaker S1, S2 or a bass module BM may also generate sound optimization audio along with the audio device 100.

FIG. 3B illustrates a functional block diagram of additional aspects of the audio device 100. In particular, FIG. 3B illustrates how the audio device calibrates and optimizes according to data received from the mobile device 200. As shown in FIG. 3B, the controller 101 includes an equalizer adjustor 115, a variable equalizer 117, and a transceiver 175. When the audio device 100 renders the microphone calibration audio 111 (as shown in FIG. 3A), the microphone calibration audio 111 is captured by the microphone 201 of the mobile device 200 arranged on top of the audio device 100. The mobile device 200 generates a microphone calibration data set 202 based on the captured microphone calibration audio 111. The transceiver 275 of the mobile device 200 then wirelessly transmits the microphone calibration data set 202. In a preferred example, the microphone calibration data set 202 is transmitted via Wi-Fi. In other examples, the microphone calibration data set 202 may be transmitted via any other practical wireless protocol, such as Bluetooth. The transceiver 175 receives the microphone calibration data set 202 and provides the microphone calibration data set 202 to the equalizer adjustor 115.

In some examples, a reference microphone 105 is incorporated into the audio device 100 to further characterize the microphone 201 of the mobile device 200. In the example of FIG. 3B, the reference microphone 105 captures the microphone calibration audio 111 generated by the acoustic transducers 103 and generates a reference audio data set 112 based on the captured microphone calibration audio 111. The reference audio data set 112 is then provided to the equalizer adjustor 115.

Once the microphone 201 of the mobile device 200 has been characterized, the mobile device 200 is moved a first optimization location L1 away from the audio device 100, and the acoustic transducers 103 generate sound optimization audio 113 as shown in FIG. 3A. The microphone 201 of the mobile device 200 captures the sound optimization audio 113 and generates a sound optimization data set 204. The transceiver 275 of the mobile device 200 then transmits the sound optimization data set 204 via Wi-Fi. In other examples, the sound optimization data set 204 may be transmitted via any other practical wireless protocol, such as Bluetooth. The transceiver 175 of the audio device 100 receives the sound optimization data set 204 and provides the sound optimization data set 204 to the equalizer adjustor 115. This process may be repeated for several optimization locations L, resulting in several sound optimization data sets 204 being provided to the equalizer adjustor 115.

The equalizer adjustor 115 uses the microphone calibration data set 202 and the sound optimization data sets 204 to generate an equalization parameter 106. The equalization parameter 106 may define one or more equalization curves across the range of audible sound for each of the acoustic transducers 103 of the audio device 100. These equalization curves are generated to optimize output audio rendered by the acoustic transducers 103. For example, the equalization adjustor 115 may compare aspects of the microphone calibration signal 102 to the microphone calibration data set 202 to generate a microphone characterization data set defining the impact of the microphone 201 on the captured microphone calibration audio 111. In other examples, the microphone characterization data set may be generated by comparing the microphone calibration data set 202 to the reference audio data set 112 generated by the reference microphone 105. The equalizer adjustor 115 may then remove data corresponding to the microphone characterization data set from the sound optimization data set(s) 204, ensuring that the equalization parameter 106 generated based on the sound optimization data set(s) 204 is mobile device microphone-agnostic.

The equalizer adjuster then generates the equalization parameter 106 based on the sound optimization data set(s) 204 which have been calibrated to remove the microphone characterization data. In some examples, the equalization parameter 106 may be generated by comparing the calibrated sound optimization data set(s) 204 to the sound optimization signal 104. This comparison may be used to determine the impact of the environment E (as shown in FIGS. 1A-1C) on audio rendered by the acoustic transducers 103.

The equalization parameter 106 is then provided to the variable equalizer 117. The equalization parameter 106 determines frequency characteristics of an equalization curve of the variable equalizer 117. In some examples, an audio device 100 with several acoustic transducers 103 may include a variable equalizer 117 for each acoustic transducer 103 for more precise optimization. The variable equalizer 117 uses the adjusted equalization curve to adjust an output audio data set 108. The output audio data set 108 includes audio data to be rendered to acoustic transducers 103. For example, the output audio data set 108 could include entertainment audio, such as streaming music, an audiovisual soundtrack, etc. In further examples, the output audio data set 108 could include audio corresponding to a telephone conversation. The variable equalizer 117 generates an optimized output signal 110 based on the output audio data set 108 and the equalization parameter 106. The acoustic transducer(s) 103 then generate optimized output audio 119 based on the optimized output signal 110. This optimized output signal 110 is optimized for the environment E containing the audio device 100 using the mobile device 200, rather than a specialized headset or other specialized optimization devices. In some further examples, the optimized output signal 110 may also be provided to a bass module BM, such as the bass module BM illustrated in FIGS. 1A and 1C. The bass module BM may generate additional, low frequency, optimized output audio.

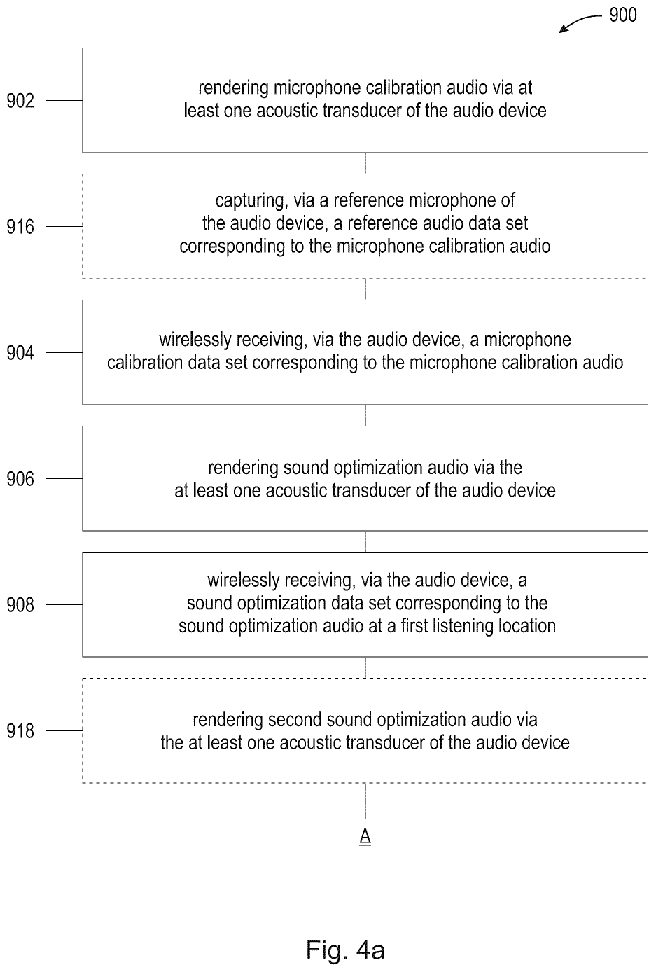

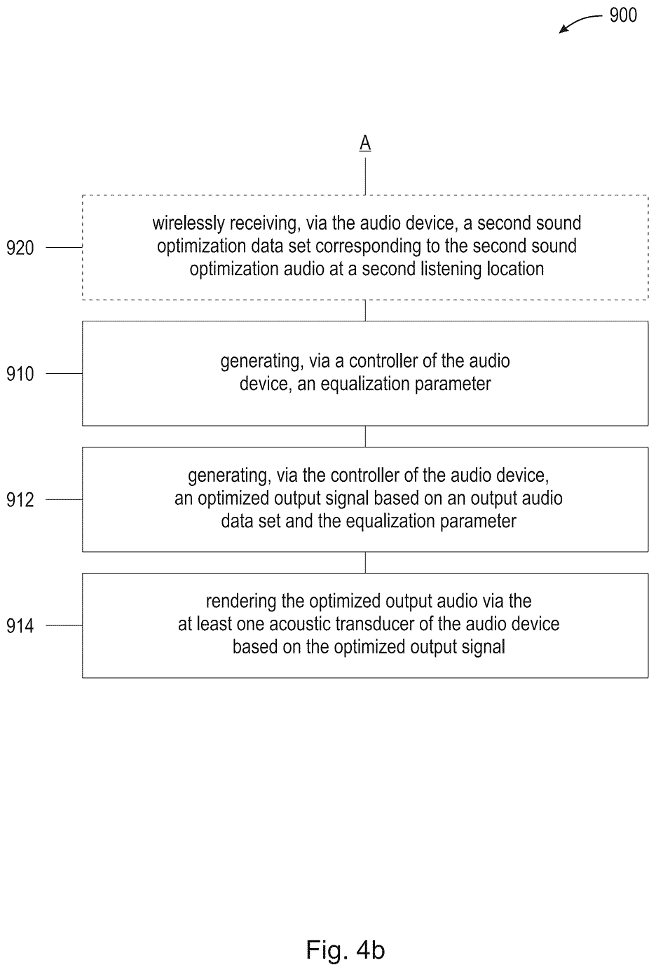

FIGS. 4A and 4B show a flow chart of a method 900 for optimizing output audio rendered by an audio device 100. Referring to FIGS. 1A-4B, the method 900 includes, in step 902, rendering microphone calibration audio 111 via at least one acoustic transducer 103 of the audio device 100.

The method 900 further includes, in step 904, wirelessly receiving, via the audio device 100, a microphone calibration data set 202 corresponding to the microphone calibration audio 111.

The method 900 further includes, in step 906, rendering sound optimization audio 113 via the at least one acoustic transducer 103 of the audio device 100.

The method 900 further includes, in step 908, wirelessly receiving, via the audio device 100, a sound optimization data set 204 corresponding to the sound optimization audio 113 at a first listening location L1.

The method 900 further includes, in step 910, generating, via a controller 101 of the audio device 100, an equalization parameter 106 based on the sound optimization data set 204 and the microphone calibration data set 202.

The method 900 further includes, in step 912, generating, via the controller 101 of the audio device 100, an optimized output signal 110 based on an output audio data set 108 and the equalization parameter 106.

The method 900 further includes, in step 914, rendering optimized output audio 119 via the at least one acoustic transducer 103 of the audio device 100 based on the optimized output signal 110.

The method 900 further includes, in optional step 916, capturing, via a reference microphone 105 of the audio device 100, a reference audio data set 112 corresponding to the microphone calibration audio 111. The equalization parameter 106 is further based on the reference audio data set 112.

The method 900 further includes, in optional step 918, rendering second sound optimization audio 113b via the at least one acoustic transducer 103 of the audio device 100.

The method 900 further includes, in optional step 920, wirelessly receiving, via the audio device 100, a second sound optimization data set 204b corresponding to the second sound optimization audio 113b at a second listening location L2. The equalization parameter 106 is further based on the second sound optimization data set 204b.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. An audio device, comprising at least one acoustic transducer and a controller, wherein the controller is configured to:
render microphone calibration audio via the at least one acoustic transducer;
wirelessly receive a microphone calibration data set corresponding to the microphone calibration audio;
render sound optimization audio via the at least one acoustic transducer;
wirelessly receive a sound optimization data set corresponding to the sound optimization audio at a first listening location;
generate an equalization parameter based on the sound optimization data set and the microphone calibration data set;
generate an optimized output signal based on an output audio data set and the equalization parameter; and
render optimized output audio via the at least one acoustic transducer based on the optimized output signal.

2. The audio device of claim 1, further comprising a reference microphone configured to capture a reference audio data set corresponding to the microphone calibration audio, wherein the equalization parameter is further based on the reference audio data set.

3. The audio device of claim 1, wherein the microphone calibration data set and/or the sound optimization data set is received via Wi-Fi.

4. The audio device of claim 1, wherein the microphone calibration data set corresponds to audio captured proximate to the audio device.

5. The audio device of claim 1, wherein the audio device is a soundbar.

6. The audio device of claim 1, wherein the microphone calibration data set is wirelessly received from a mobile device.

7. The audio device of claim 1, wherein the sound optimization data set is wirelessly received from a mobile device.

8. The audio device of claim 1, wherein the controller is further configured to:
render second sound optimization audio via the at least one acoustic transducer; and
wirelessly receive a second sound optimization data set corresponding to the second sound optimization audio at a second listening location, wherein the equalization parameter is further based on the second sound optimization data set.

9. The audio device of claim 1, wherein the microphone calibration audio and/or the sound optimization audio are within a frequency range of 20 Hz to 20 kHz.

10. A method for optimizing output audio rendered by an audio device, comprising:
rendering microphone calibration audio via at least one acoustic transducer of the audio device;
wirelessly receiving, via the audio device, a microphone calibration data set corresponding to the microphone calibration audio;
rendering sound optimization audio via the at least one acoustic transducer of the audio device;
wirelessly receiving, via the audio device, a sound optimization data set corresponding to the sound optimization audio at a first listening location;
generating, via a controller of the audio device, an equalization parameter based on the sound optimization data set and the microphone calibration data set;
generating, via the controller of the audio device, an optimized output signal based on an output audio data set and the equalization parameter; and
rendering the optimized output audio via the at least one acoustic transducer of the audio device based on the optimized output signal.

11. The method of claim 10, wherein the microphone calibration data set is captured by a mobile device arranged proximate to the audio device.

12. The method of claim 11, wherein the mobile device is arranged on top of the audio device.

13. The method of claim 10, further comprising:
capturing, via a reference microphone of the audio device, a reference audio data set corresponding to the microphone calibration audio, wherein the equalization parameter is further based on the reference audio data set.

14. The method of claim 10, wherein the microphone calibration data set and/or the sound optimization data set is received via Wi-Fi.

15. The method of claim 10, wherein the audio device is a soundbar.

16. The method of claim 10, wherein the sound optimization data set is captured by a mobile device positioned at the first listening location.

17. The method of claim 10, wherein the sound optimization data set is wirelessly received from a mobile device.

18. The method of claim 10, further comprising:
rendering second sound optimization audio via the at least one acoustic transducer of the audio device; and
wirelessly receiving, via the audio device, a second sound optimization data set corresponding to the second sound optimization audio at a second listening location, wherein the equalization parameter is further based on the second sound optimization data set.

19. The method of claim 18, wherein the second sound optimization data set is captured by a mobile device positioned at the second listening location.

20. The method of claim 10, wherein the microphone calibration audio and/or the sound optimization audio are within a frequency range of 20 Hz to 20 kHz.
